(19) United States
(12) Patent Application Publication
(10) Pub. No.: US 2004/0254801 A1
(43) Pub. Date: Dec. 16, 2004

(54) Method and device for monitoring flows of goods

(76) Inventor: Sergej Toedtli, Wollerau (CH)

Correspondence Address: Ladas & Parry, 26 West 61st Street, New York, NY, 10023, US

(21) Appl. No.: 10/494,154

(22) PCT Filed: Nov. 6, 2001
(86) PCT No.: PCT/IB01/02074

(51) Int. Cl. G06F 17/60

(52) U.S. Cl. 705/1

(57) ABSTRACT

In the present method, the flow of articles through a distribution network with article positions (P1, P2, . . . ) and paths connecting the article positions is monitored. The movements of each article are recorded in a data base (2). For each article, event counts are determined, which indicate how often it runs through a given path or arrives at a given article position. The event counts are tested for certain criteria and a warning is issued if the criteria are not fulfilled. This procedure allows, depending on the criteria, to locate grey market activities, inefficiencies or defective articles.

The invention relates to a method and a device for monitoring article flows of articles in a distribution network according to the preamble of claim 1.

In modern logistics, it is common to dispatch articles through, in part, fairly complex distribution networks, where the articles pass various article positions, such as e.g. the storehouse of the manufacturer, various intermediate storehouses of the manufacturer, storehouses of distributors or storehouses of points of sale. The article positions are, viewed in abstract manner, connected by paths describing all the possible movements of the articles. On its way, the article passes a plurality of article positions and paths, and it may also arrive at a given article position or pass through a given path several times.

It is desirable to have a certain degree of control over the article flow, i.e. in order to avoid unnecessary movements and/or in order to detect irregularities, such as grey market activities.

In conventional systems, it is presently—at best—recorded in a database which article positions an article has run through and where it is presently. The object of the present invention is to provide a method and a device of the type mentioned initially that allow a better monitoring of the article flow.

This object is achieved by the method according to claim 1.

Therefore, according to the invention, it is determined for at least part of the paths and/or article positions how often an article has passed a path or how often it as reached an article position, respectively. From this, “event counts” are determined for each article, which are attributed to the corresponding paths or article positions, respectively. An event count therefore indicates how often the article has passed the given path or how often it has reached the corresponding article position, respectively.

These event counts are then checked by means of a checking rule in view of predefined criteria. If the checking rule is not fulfilled, a warning is issued. This allows to check in flexible manner if the movements of an article correspond to certain requirements.

Advantageously, the checking rule defines maximally allowable event counts for at least part of the paths and/or article positions. The warning is issued if at least one of the event counts of an article exceeds the maximally allowable event count. For example, it is thus possible to set down that an article must never reach a given article position and/or never pass a given path. For this purpose, the corresponding maximum event count is set to 0. It can also be set down that an article may pass a given path several times, but e.g. not more than 10 times. In that case, the corresponding event count is set to 10.

Further advantageous embodiments and applications are described in the dependent claims as well as the now following description with reference to the figures. These show:

FIG. 1 a schematic representation of a distribution network,

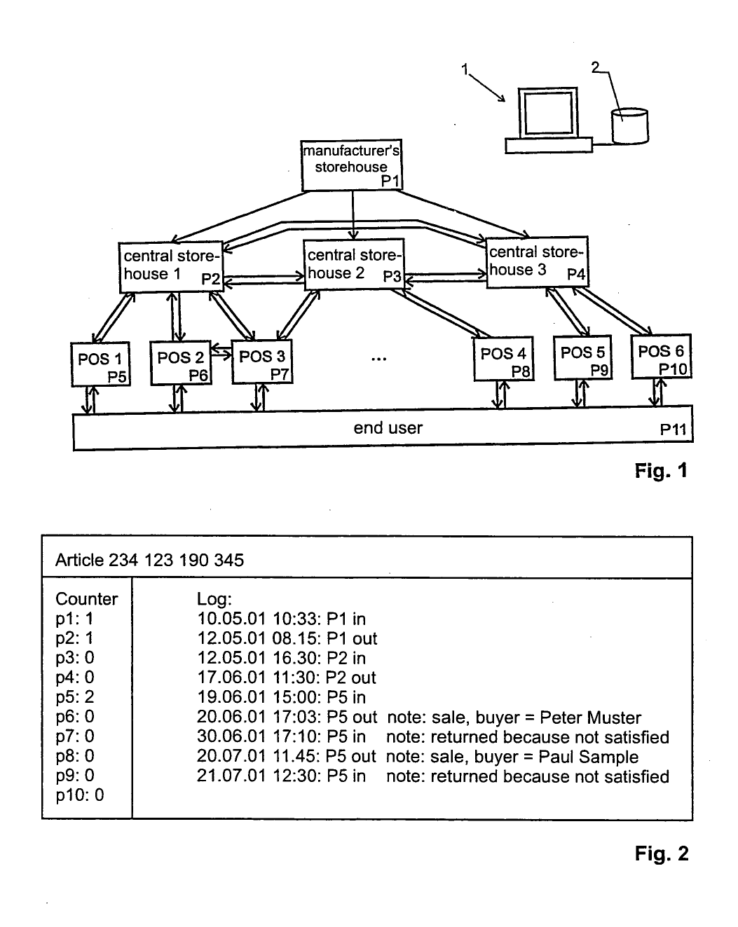

FIG. 2 the database entry for a first embodiment of the invention,

FIG. 3 the database entry for a second embodiment of the invention, and

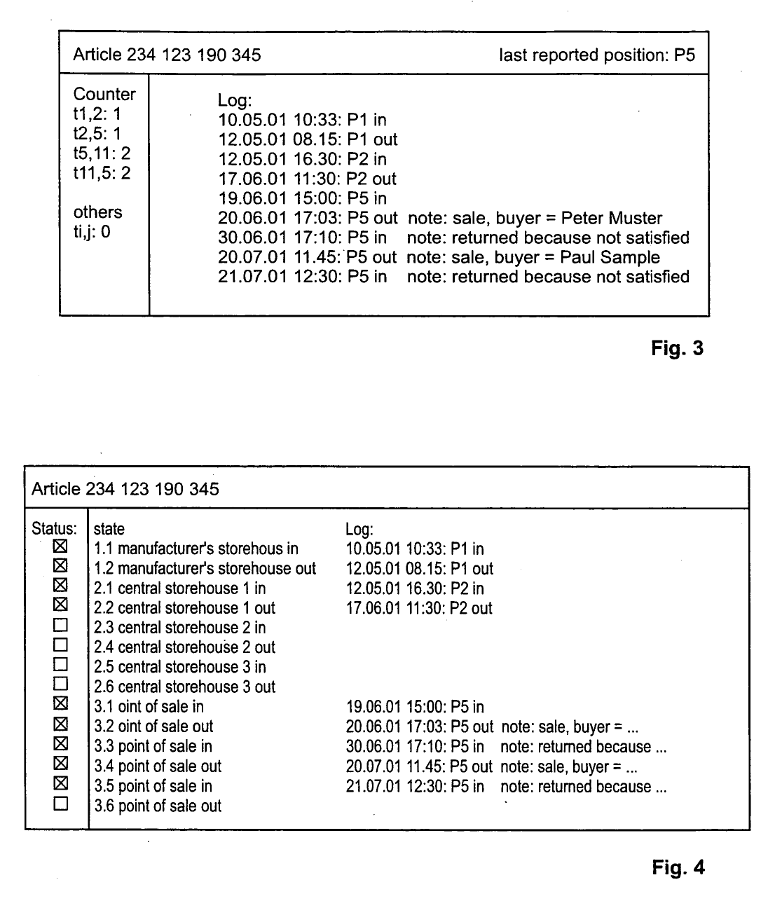

FIG. 4 the database entry for a third embodiment of the invention.

FIG. 1 shows, as an example, a possible embodiment of a distribution network for a given kind of articles.

The rectangular symbols represent the possible article positions P1, P2, . . . , the arrows some of the possible paths.

Article position P1 e.g. corresponds to the storehouse of the manufacturer of the articles. From this storehouse, the articles are usually delivered to various central storehouses P2, P3, P4, which are e.g. attributed to a region and/or a distributor. From the central storehouses the articles arrive at various points of sale (POS=“point of sale”) P5 . . . P10, from where they are sold to the end users. In the present example, the end users are regarded in simplified manner as a single article position.

In real operation of the distribution network, the articles will not always wander linearly from the top to the bottom. For example, the central storehouses P2, P3, P4 can exchange articles between them and, depending on agreements, also the points of sale. Further it is possible that a point of sale can be stocked from different central storehouses. “Upward” material flows are possible as well, e.g. when a point of sale sends an article back to a central storehouse or an end user returns an article.

The arrows in FIG. 1 show some of the possible paths between the article positions.

For monitoring the movement of the articles in the distribution network, a computer 1 is provided. It operates a database 2, where the data described in the following are recorded. Furthermore, it is connected to input stations of the individual article positions. These can e.g. be barcode readers or manually operable input terminals. With these input devices it is announced to computer 1 when an article reaches an article position and when it is leaving it again. In order to distinguish between the individual articles, a unique article number is attributed to each article, which can e.g. be recorded on the article itself or on a packaging of the article.

In the following, different embodiments of the method according to the invention are described. In each of these embodiments, an entry for each article is maintained in the database, which records several “event counts” of the given article or allows the determination of the event counts from the data recorded for the article. Each event count describes how often an article has arrived at a given article position or how often the article has passed a path between two article positions.

In FIG. 2, a first embodiment of a corresponding database entry for an article is shown. In this embodiment, ten counters are provided for each article for event counts p1, p2, . . . p10, which record how often the article has arrived at the corresponding article position. In addition to this, an entry titled “Log” is provided, which records the history of the article in detail, as it has been recorded from the inputs at the input devices at the article positions. The entry stores, inter alia, when the article has reached which article position and when it has left it. In the present case, the article has arrived from position P1 to P2 and from there to P5. In P5 it has been sold twice and returned twice. Hence, event count p5 is equal to 2.

The entries in the database are checked regularly or after mutations. For this purpose, the event counts (in the case of FIG. 2 the counts p1 to p10) are fed to a checking rule R. In the case of the first embodiment, this rule can e.g. have the following form:

R(p1, . . . , p10)=fulfilled if pi<Li for all i otherwise not fulfilled (1)

wherein L1, L2, L3, . . . are maximally allowable event counts, i.e. limits for the event counts p1 to p10. In other words, rule R is fulfilled if none of the event counts pi is larger than the corresponding maximally allowable event count Li.

For example, the following maximally allowable event counts can be provided: L1=1, L2=5, L3=5, L4=5, L5=L6= . . . =L10=2. Hence, in this embodiment, an article can reach each central storehouse up to five times, but each point of sale only twice. This checking rule would be fulfilled by the example of FIG. 2—if, however, another sale and return would take place at the same point of sale, the checking rule is not fulfilled anymore.

If it is found that an article does not fulfil checking rule R anymore, a warning is issued. The warning can e.g. be addressed to the operator of the database, or it can start an automatic process in computer 1. When a warning occurs, suitable steps are initiated. If, for example, an article arrives at the same point of sale very often, the article might be defective, or counterfeits of the article might be in circulation. Details in the history of the article, which may give further clues for the cause of the problem, can be retrieved from the Log entry.

The checking rule may also be more complex than shown in equation (1). For example, alternatively or in addition of the first condition of equation (1), it may be set down that p5 and p6 must be zero if p2 is zero, i.e. an article can only then be sold at the points of sale P5 or P6 if it has passed the central storehouse P2. By means of rules of this kind, grey market activities or inefficiencies in the distribution chain can be found.

A second embodiment of the invention is shown in FIG. 3. In this embodiment, 11×11 event counts t_{i,j} are recorded in the database entry. They record how often the article has arrived at article position Pj from article position Pi. In addition, the last reported article position is recorded in the database entry such that, upon report-of a new article position, the corresponding event count can be increased by 1.

The entries in the database are again checked by means of a checking rule R. In the case of the second embodiment, this rule may e.g. have the following form:

R(t_{i,j})=fulfilled if t_{i,j}<M_{i,j} for all i,j otherwise not fulfilled, (2)

wherein M_{i,j} are the maximally allowable event counts, i.e. the limits for the event counts t_{i,j}.

The second embodiment has the advantage that certain distribution paths can be blocked in simple manner. For example, the values M_{i,j} for i and j between 5 and 10 can be set to 0, i.e. a direct transition of articles between the points of sale is not allowed. Also, the values M_{i,i} (for all i) can be set to 0 because a corresponding transition indicates an error state.

Similar to the first example, a more complex condition than the one according to equation 1 can be used in this case as well. For example, it can be required that all t_{i,j} for i>1 and j>1 must be 0 as long as all t_{1,j} are 0, i.e. the article must only appear in the distribution network if it has left the manufacturer's storehouse.

In particular, the second embodiment allows to attribute different maximally allowable event counts to paths in opposite directions between two positions Pi, Pj. For example, T_{2,5}=1 and T_{5,2}=0, i.e. point of sale P5 can obtain an article from central storage P2 but must not give the article back to central storage P2, or T_{j, 11}=1 and T_{11,j}=0 for all j, i.e. the article must not go back to the article positions from the end user.

FIG. 4 shows a third embodiment of the invention. In this example, the article positions P5 to P10 are grouped into a single article position. Instead of the counts, a binary list of states are given for each article in the database, which are numbered by numerals 1.1 to 3.6 in the example. Each state can be marked by a status flag. If the flag is set, the corresponding state has been taken. In that case, it must not be taken again.

Each time a new article position is announced to computer 1, it is checked if a corresponding unused status is available. If the point of sale P5 announces (as first point of sale) the arrival of the article, the first free state “point of sale in” is searched for (state 3.1) and marked by setting the status flag. When the article is sold by the point of sale, the first state “point of sale out” (state 3.2) is occupied, state 3.1 remains occupied. If the article comes back to the point of sale, the second state “point of sale out” (3.3) is used, etc. If no more suitable state is available (e.g. when the article arrives at the point of sale for the fourth time), a warning is issued.

The third embodiment of FIG. 4 functions similarly to the first embodiment of FIG. 2 in case that in the embodiment of FIG. 2 all points of sales are grouped into a single article position. The third embodiment counts, e.g., how often an article arrives at the article position “point of sale”At the first time, state 3.1 is set, at the second time state 3.3 and at the third time state 3.5. The article must not assume the article position more than three times.

Preferably, database 2 is designed in all embodiments in such a manner that the event counts cannot be reduced but only increased, i.e. for at least one user group no user interface is provided for a reduction, but only for an increase of the event counts. This allows to decrease the danger of abusive manipulations of the database. In the first two embodiments, this can be achieved by making it possible to increase the values pi and t_{i,j} only, but not to decrease them. In the third embodiment, this is achieved by making it possible to set the status flags, but not to reset them.

Similarly, it should, at least for one user group, be impossible to delete entries from the entry titled “Log”

As it is seen from a comparison of the embodiments, the event counts can have different meaning and they can be stored in different manner. It is also possible to combine the various embodiments of the invention. For example, it is possible to record the event counts pi from the first embodiment and the event counts t_{i,j} from the second embodiment and take them into account in the checking rule.

It is further possible to store only the Log entry permanently in the database and to derive the event counts to be checked from the Log entry when required. This is, however, in particular when the number of articles is large, computationally expensive.

The article positions can be attributed uniquely to the various locations where an article can be. As it has already been shown, however, it is also possible to define “virtual” article positions, e.g. by grouping some locations (e.g. all points of sale or all end users) into a single article position. Neither is it necessary to take account of all possible article positions or paths when storing and/or checking.

The checking rule R can be the same for all articles, or it can be adapted individually to each article or to subgroups of the articles. In this case, the data entry of each article further contains, for example, information indicative of how the checking rule should look like. For example, it can be set down for an article that it must not reach certain article positions, while another article (which has e.g. been sold under different conditions or fulfils different quality criteria) can reach all article positions.

The device according to the invention for carrying out the method described here comprises e.g. the computer 1, the database 2 as well as a program for carrying out the described steps.

1. A method for monitoring article flows in a distribution network, wherein the distribution network comprises a plurality of article positions and paths connecting the article positions, and wherein the positions and or the paths reached by an article are recorded in a data base, said method comprising the following steps
determining, for at least a part of the paths and/or article positions, how often the article has run through a given path or has reached a given article position, respectively, for determining an event count for the article attributed to the corresponding path or article position, respectively,
checking the event counts of an article by means of a checking rule, and
issuing a warning upon non-fulfilment of the rule.

2. The method of claim 1, wherein the checking rule defines maximally allowable event counts for at least a part of the paths and/or article positions, wherein the rule is not fulfilled if at least one event count of an article exceeds the corresponding maximally allowable event count.

3. The method of claim 2, wherein at least one of the maximally allowable event counts is larger than or equal to 2.

4. The method of claim 2, wherein at least one of the maximally allowable event counts is equal to 0.

5. The method of claim 2, wherein for at least a part of the pairs of article positions a first path in one direction and a second path in the opposite direction is provided, each of which an event count is attributed to, and wherein different maximally allowable event counts for the two directions are used.

6. The method of claim 1, wherein the data base provides a user interface for at least one user group, which allows an increase, but not a decrease, of the event counts.

7. The method of claim 1, wherein it is recorded for each article when it has reached an article position and/or when it has left it.

8. The method of claim 1, wherein the checking rule is such that at least part of the event counts can be larger than 1 without the warning being issued.

9. The method of claim 1, wherein the check rule is individual for single articles or subgroups of the articles.

10. A device for monitoring article flows in a distribution network characterized by means (1, 2) for carrying out the steps of the method of claim 1.

11. A method for monitoring article flows in a distribution network, wherein the distribution network comprises a plurality of article positions and paths connecting the article positions, said method comprising the steps of
recording the article positions and or the paths reached by an article in a data base,
determining, for at least a part of the paths and/or article positions, how often the article has run through a given path or has reached a given article position, respectively, for determining an event count for the article attributed to the corresponding path or article position, respectively,
checking the event counts of an article by means of a checking rule, and
issuing a warning upon non-fulfilment of the rule.

12. A method for monitoring article flows in a distribution network, wherein the distribution network comprises a plurality of article positions and paths connecting the article positions, said method comprising the steps of
recording the article positions and or the paths reached by an article in a data base,
determining, for at least a part of the paths and/or article positions, how often the article has run through a given path or has reached a given article position, respectively, for determining an event count for the article attributed to the corresponding path or article position, respectively,
checking the event counts against predefined maximally allowable event counts for at least a part of the paths and/or article positions, and
issuing a warning if at least one event count of an article exceeds the corresponding maximally allowable event count.
